(19) United States
(12) Patent Application Publication
(10) Pub. No.: US 2016/0078386 A1
(43) Pub. Date: Mar. 17, 2016

(54) Branch Versioning for Process Management

(71) Applicant: Wolfgang Herzog, Reilingen (DE)

(72) Inventor: Wolfgang Herzog, Reilingen (DE)

(21) Appl. No.: 14/484,579

(22) Filed: Sep. 12, 2014

(51) Int. Cl. G06Q 10/06; G06F 17/30

(52) U.S. Cl. CPC G06Q 10/06316; G06F 17/30327

(57) ABSTRACT

Business process structures and modifications thereto in one or more branches may be reflected in database entries that include a key identifying the node and branch and one or more attributes associated with the node. Various embodiments provide systems, methods, and machine-readable media that facilitate updating the database entries to create a modified branch version of a business process structure, merge the branch version into a parent branch thereof, resolve conflicts between different versions of the business process structure, and/or reconstruct the business process structure within a selected branch context.

### TECHNICAL FIELD

This document relates generally to the software-assisted process management, and more particularly to managing multiple versions of a process and process-related data.

### BACKGROUND

Large businesses usually operate in accordance with well-defined business processes. A business process generally corresponds to a particular task to be performed in certain business situations, or “scenarios,” such as when a customer places an order, when supplies for the next month are ordered, or when financial data are gathered and aggregated at the end of a quarter to evaluate the financial performance of the business, to list but a few examples. Under a given scenario, multiple business processes may arise, and each process may, in turn, consist of multiple steps to be carried out in a specified sequence. For example, the process of processing a customer order may involve receiving a purchase request, checking availability of the desired item, informing the customer of an anticipated delivery date if the item is in stock, or of the anticipated date on which the item will be available again if it is on backorder, obtaining the customer's payment information, verifying the payment information, and finally releasing the order to the business's shipping department.

Businesses can implement many of their business processes with the help of existing software packages, such as customer relationship management software, enterprise resource planning software, etc. In addition, platforms and tools are available that help businesses define business processes and integrate the individual software programs, resources, etc. accordingly. The programmatically defined business processes can be modified to reflect any changes made, or anticipated to be made, to the underlying actual business processes. Sometimes, multiple versions of the same business process exist. For example, an active “productive version” of the business process may specify how business is done currently, while a passive “development version” of the process may implement an updated business process that undergoes testing in a restricted, controlled setting prior to business-wide real-world deployment. If changes to the same process are made in parallel in two different versions, conflicts can arise. Anticipating and avoiding such conflicts, or managing them after they have occurred, generally entails a lot of overhead, and has in the past imposed significant limits on the practicable size of business processes. For example, the operations of a large and complex business may heretofore have been defined separately for each business unit, and connections between the business processes of the individual units may have been established and maintained manually.

### BRIEF DESCRIPTION OF DRAWINGS

The present disclosure illustrates embodiments of the inventive subject matter by way of example and not limitation, and with reference to the following drawings:

FIG. 1 depicts an example business process structure in accordance with an embodiment.

FIG. 2 is a functional block diagram illustrating a system for managing business process versions in accordance with various embodiments.

FIG. 3 is an example branch tree illustrating business process versioning in accordance with an embodiment.

FIGS. 4A-4C illustrate different branch versions of the business process structure of FIG. 1.

FIG. 5 is a table showing the database entries for the business process versions of FIGS. 1 and 4A-4C.

FIG. 6 is a flow chart illustrating a method of reconstructing a business process version in accordance with various embodiments.

FIGS. 7A and 7B illustrate the updated trunk version and the new inactive branch version, respectively, following activation of the branch version of FIG. 4A.

FIGS. 8A and 8B illustrate updates to the branch versions of FIGS. 4B and 4C following activation of the branch version of FIG. 4A.

FIG. 9 illustrates updates to the table of FIG. 5 reflecting the new trunk and branch versions of FIGS. 7A, 7B, 8A, and 8B.

FIGS. 10A and 10B illustrate conflict resolution, and the resulting updated branch version, for the branch version of FIG. 8A.

FIG. 11 is a flow chart illustrating a method of deploying a business process version in accordance with various embodiments.

FIGS. 12A and 12B illustrate the updated trunk version and the new branch version, respectively, following deployment of the branch version of FIG. 8A.

FIG. 13 is a flow chart illustrating methods for managing business process versions in accordance with various embodiments.

FIG. 14 is a block diagram illustrating an example of a software architecture that may be installed on a machine, according to example embodiments.

FIG. 15 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. For the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

The embodiments disclosed herein implement a versioning mechanism for business processes that keeps track of changes made in parallel to multiple versions of the same process, allowing the multiple versions to be developed independently while facilitating their eventual merging into a single productive version. In some embodiments, version-specific data for a business process contains only “delta information” reflecting the modifications made relative to a parent version from which it is derived, rather than a complete definition of the entire modified business process structure. Thus, only a small amount of duplicative data is physically stored, reducing overall memory requirements associated with maintaining multiple process versions. Various embodiments not only reduce user efforts by streamlining version management and integration, but also provide users with a convenient means to obtain an overview of the versions under development and make comparisons therebetween, e.g., for prophylactic use in spotting any compatibility issues or inconsistencies.

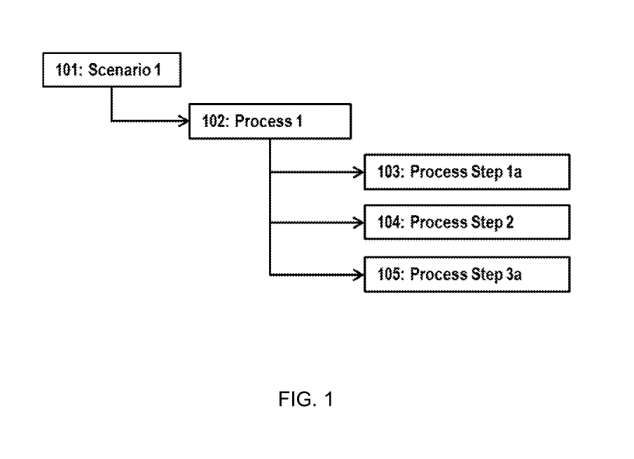

In embodiments, business processes may be organized in a process hierarchy that manages different levels—e.g., scenario, process, and process step—in a tree structure. While three levels are used herein for purposes of illustration, different numbers and types of levels may generally be used. The levels that are available for the definition of business-process structures may themselves be defined (e.g., by the user, a system designer, or a system administrator) in a process model. FIG. 1 diagrammatically illustrates the tree structure of an example business process in a three-level hierarchy. This example process, labeled “Process 1,” arises under (in other words, is a “child process” of) “Scenario 1” and includes three (children) process steps, labeled “Process Step 1a,” “Process Step 2,” and “Process Step 3a.” To provide a specific real-world example, the scenario may be the activities of the procurement department within a business, the process may be placement of an order as tied to a particular user interface for placing orders, and the process steps may include checking the existing inventory, generating a list of items and quantities needed, and dispatching the order to the supplier. Each element within the hierarchical structure constitutes a node of the tree (depicted as a box), and, as shown, each node has an associated unique identifier (ID) (e.g., 101 for Scenario 1, 102 for Process 1, and 103, 104, and 105 for the three process steps). The hierarchical relations between the nodes are indicated as arrows (e.g., Process Step 1a with node ID 103 is a child of Process 1 with ID 102).

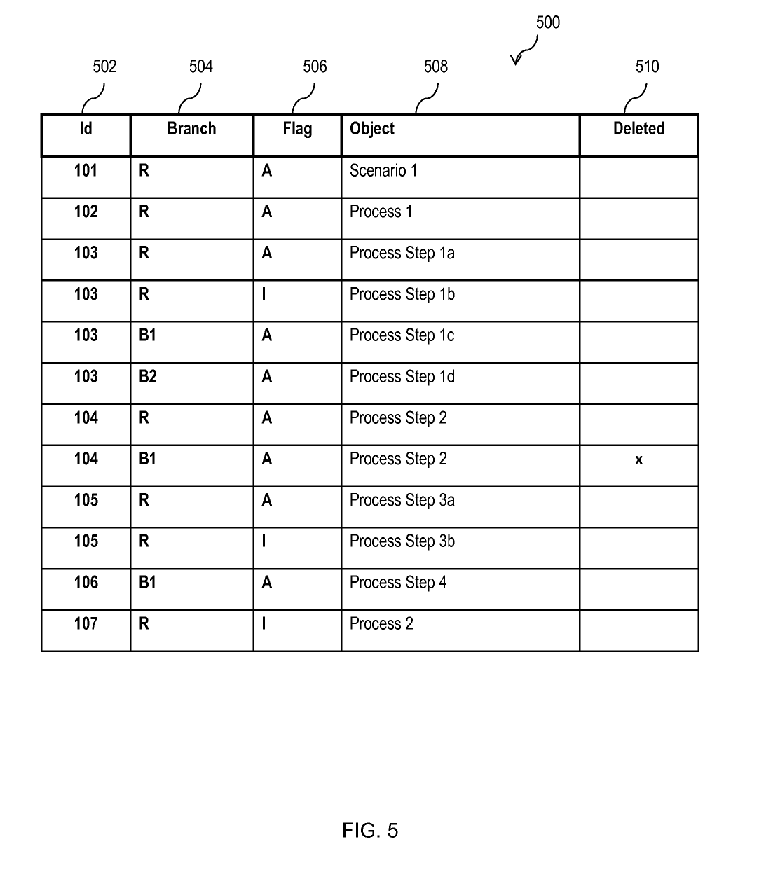

In some embodiments, the tree structure itself is stored, in computer memory, as a data structure that specifies only the IDs of all the nodes and their hierarchical relations. The data structure may, for instance, take the form of a table using the node ID as the key and the parent node ID as the attribute. To store multiple versions of a node, the key may be extended as illustrated below with respect to FIG. 5. An additional key may be used to separate entire tree structures stored in a single table. Data associated with the tree structure may be stored in one or more separate databases or tables, for which the node ID may serve as the key (or, as explained further below, a portion of the key). The database may contain one or more columns (in addition to the key column) that store, for each node, associated attributes and/or objects. In some alternative embodiments, the hierarchical relations between the nodes (which define the tree structure) and the data (i.e., attributes and/or objects) associated with the nodes may be integrated in a single database. In some embodiments, objects (such as documents or transactions associated with a node) are treated as child nodes and stored in the tree structure; the table for the tree structure may then also include an attribute column specifying the type of node (e.g., scenario process, process step, document, or transaction). Additional attributes may be stored in separate tables, e.g., one for language-independent attributes and one for language-dependent attributes; the table for language-dependent attributes may include an additional key specifying the language. Many other implementations will be apparent to those of ordinary skill in the art.

Node attributes may include, for example, a name of the node (e.g., “Process 1” or “Process Step 2a”), a node type (e.g., scenario, process, or process step), type-specific attributes (e.g., a “process” node may have a Boolean attribute indicating whether it is a core process or not, and/or an availability attribute indicating during which hours of the days and days of the week the process is available; and a “process step” node may have a task-type attribute indicating whether the task is a service task, user task, manual task, script task, etc.), a node priority (e.g., critical, high, medium, low), or the owner of the node (e.g., the name of the person who is responsible for a business process, or of the person who created the node or who last modified the node. Objects associated with a node may include documents (e.g., policies and instructions to be followed in carrying out a particular process or process step, forms to be used, etc.), software applications or screens used in the performance of the process or process step, business objects (e.g., data structures maintained for a business unit, employee, customer, supplier, etc. involved with the process, a budget or other resource allocated thereto, and so on), or links to the foregoing. For purposes of this disclosure, it is not important to strictly distinguish between attributes and objects; accordingly, these terms are hereinafter used synonymously.

Of course, business processes and hierarchies may be, and typically are, much more extensive and complex than the example depicted in FIG. 1. Thus, it is to be understood that embodiments may generally implement tree structures including more (or, in some instances, fewer) nodes and/or different node organizations than shown. For ease of illustration and explanation, however, the example structure of FIG. 1 is referenced throughout the following description.

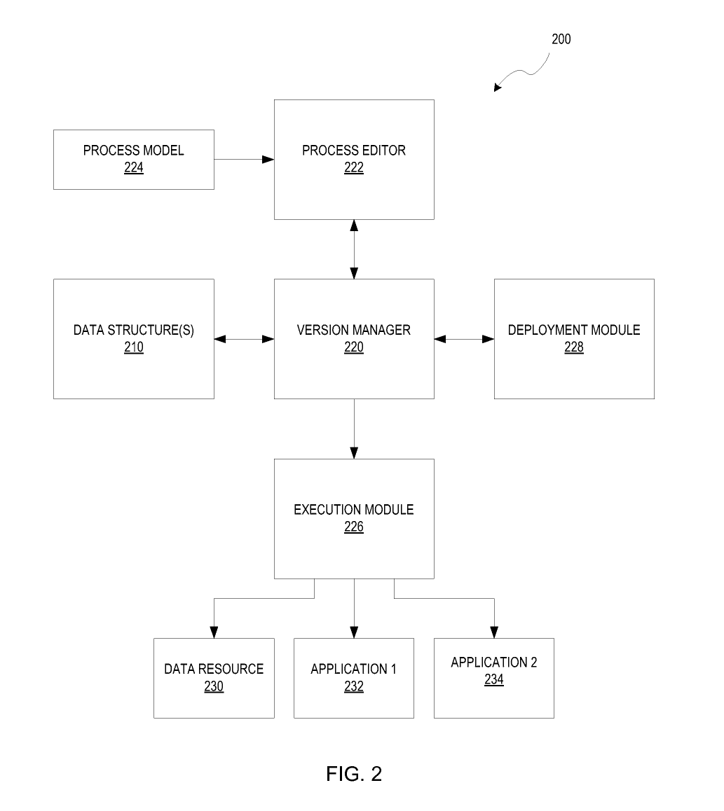

FIG. 2 illustrates an example system 200 for process and version management in accordance herewith. As depicted, the system includes one or more data structures 210 (e.g., a database stored in memory) that define the various versions of the business process structure and contain data associated therewith, and a number of modules that provide various interrelated functionalities related to the creation, modification, and use of the data structure(s) 210. These modules may generally be implemented in software (e.g., as program modules including processor-executable instructions), hardware (e.g., as special-purpose processors or other hardwired circuitry), or combinations thereof. Further, it is to be understood that the functionality collectively provided by these modules need not necessarily be organized and grouped in the manner depicted, but may be provided by different numbers and types of modules.

In the illustrated embodiment, the system 200 includes a version manager 220 with read and write access to the data structure 210. The version manager 220 may modify the data structure 210, e.g., based on user input, to reflect changes made thereto in a particular version. The user input may be received via a user interface provided by a process editor 222. In some embodiments, the process editor 222 allows a user to define the structure of a business process graphically, e.g., by dragging node symbols onto a drawing canvas and drawing connections therebetween to create a tree structure. Alternatively or additionally, the process editor 222 may provide text input fields for defining the nodes and associated data. In some embodiments, the business process structure is subject to certain constraints and limitations, such as a maximum number of hierarchy levels. These constraints may be stored in the form of a process model 224 and enforced by the process editor 222. The version manager 220 may also reconstruct a specified (e.g., user-selected) version of the business process based on the data structure(s) 210; the reconstruction process is explained in detail further below. The reconstructed process may be visualized by the process editor 222, e.g., in the form of a tree structure. The process editor 222 may display two or more versions of the business process side by side, thereby facilitating convenient comparisons between versions by the user.

The system 200 may also include an execution module 226 that can execute any version of the business process, e.g., the current productive version or, for test purposes, a development version. Execution of a business process version may involve traversing the process structure and accessing resources, such as data 230 or software applications 232, 234 associated with the nodes of the structure. The execution module 226 may communicate with the version manager 220 to receive information about the reconstructed process structure for the particular version. Further, the system 200 may include a deployment module 228 that manages the activation of a modified business process version. The deployment module 228 may be responsible for resolving any conflicts (e.g., arising from the at least partially parallel modification of the current modified version and a previously deployed modified version), as well as for updating the data structure 210, directly or via the version manager 220, to turn the modified version into the new productive version. The functionality of the system 200 will be more readily understood from the following illustration and description of various embodiments.

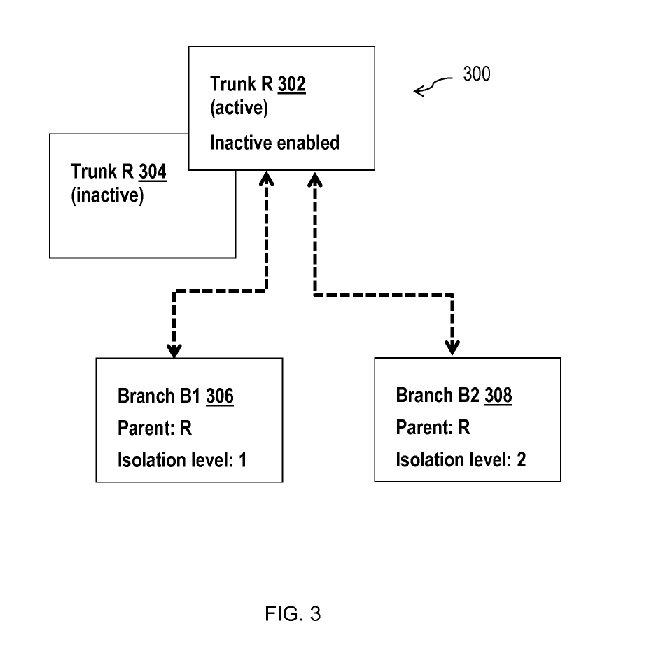

In some embodiments, different versions of a process structure are stored in the form of “branches” that contain only changes relative to the respective parent branch, rather than copies of the entire process tree structure. FIG. 3 depicts an example branch tree 300 illustrating this branch versioning concept. The main version of a process is stored in a “trunk” 302 (or “root branch”), and contains the complete process structure. This trunk 302 is the starting point of the tree of versioning branches 304, 306, 308. Apart from the trunk, each branch is based on a parent branch and contains “delta information,” i.e., specifies differences, with respect to its parent branch. The “branch version” of a business process structure is the structure of the parent branch modified and/or enhanced by the branch delta information. The branch is, thus, used as a context for changes. When a new branch is created, it contains initially no delta information and is, thus, “empty.” In this state, the branch version of the process structure is identical to its parent branch version. Changes can then be made to one or more nodes; beyond modifications of node attributes or objects, possible changes include the deletion of existing nodes or the addition of new nodes. Once one or more nodes have been changed in a branch, the branch version differs from its parent branch version for those nodes; the parent branch version itself is left untouched.

In some embodiments, a branch, including the root branch, can exist in two different contexts: active and inactive. These contexts arise when a branch (e.g., root branch 302) is enabled for inactive handling, which means that the active version (i.e., the currently deployed version; e.g., root branch 302) is locked and cannot be changed directly, while the inactive version (e.g., branch 304) provides the changeable working version. The inactive version (e.g., branch 304) is an implicit child branch of the active version (e.g., root branch 302), and it is possible to treat inactive versions just like any other branch version. In some application scenarios, however, it is beneficial to distinguish branches that reflect changes expected to be deployed in the short term from branches that are used for long-term development. For example, when a business process is originally implemented, errors and deficiencies may be revealed that should be corrected as soon as possible; changes designed to fix these errors and deficiencies may be stored in the inactive version of the branch. At the same time, the business process may already be undergoing development directed towards long-term improvements and extensions. Changes related to such long-term development may be stored in regular child branches (such as branches 306, 308). The expectation is that the inactive version of a parent branch will be deployed before any of the child branches. Rules may specify how the child branches are to be updated following deployment (or activation) of the inactive parent version, i.e., the merging of the changes of the inactive parent version into the active parent version.

In general, a change made in a child branch is not immediately visible in its parent branch. Whether a change made in a parent branch is immediately visible in its child branch, on the other hand, may depend on the usage scenario. In some use cases, e.g., if a correction has been made to a parent branch, it may be beneficial to render the change immediately visible in the child branch. In other use cases, e.g., if a child branch represents a separately installed productive version, it may be preferable to hide the changes made to the parent branch in the child branch. Branches may be classified based on the rules according to which changes made in the parent branch are propagated to the child branch (e.g., rules specifying which changes are immediately visible in the child branch and which support is available to merge any conflicting changes). In some embodiments, three “isolation levels” are defined:
In level 0 (the “dirty” isolation level), changes of the parent branch and the child branches are uncontrolled, meaning that any non-conflicting changes made to the parent branch are immediately visible in the child branch and that any conflicting changes made to the parent branch are handled using a two-way compare-and-adjust process (explained further below).
In level 1 (the “conflicts” isolation level), non-conflicting changes made to the parent branch are immediately visible in the child branch, whereas conflicting changes are isolated and may be handled using a three-way compare-and-adjust process (also explained further below).
In level 2 (the “strict” isolation level), the child branch is completely isolated from its parent branch, which means that none of the changes made to the parent branch are immediately visible in the child branch. Conflicting changes in the parent branch may be handled (at a later time) using a three-way compare-and-adjust process.

In the example branch tree of FIG. 3, branches B1 306 and B2 308 have isolation levels 1 and 2, respectively.

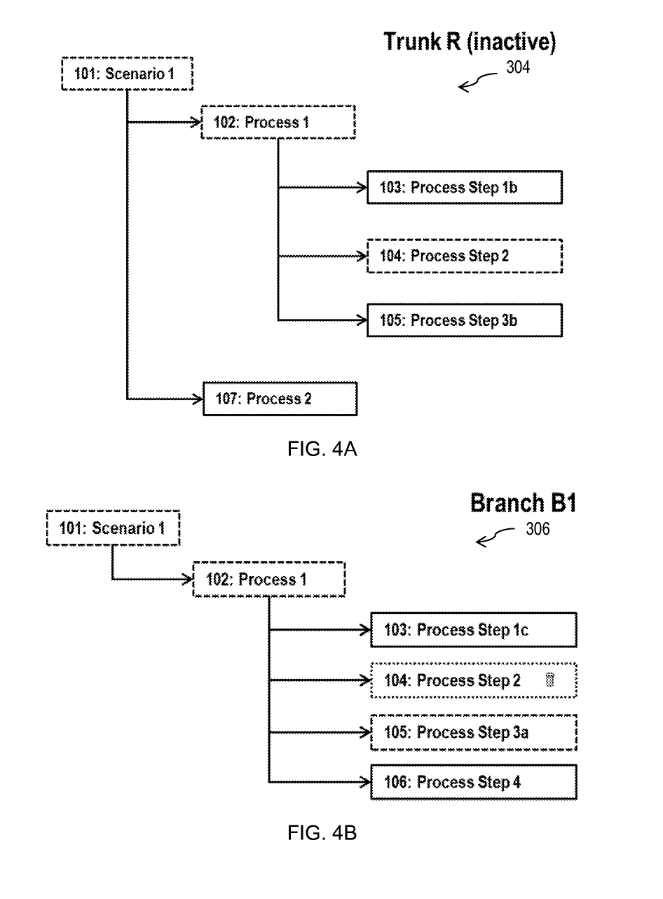

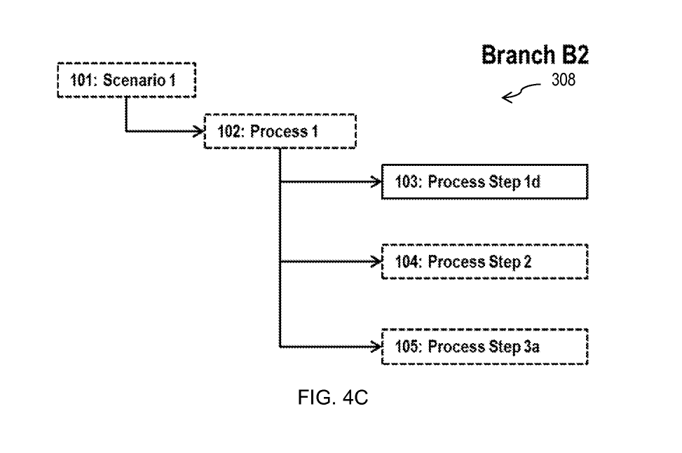

With renewed reference to the example business-process structure depicted in FIG. 1, this structure is now considered the active context of a trunk of the branch tree 300. FIGS. 4A-4C illustrate example branch versions of this structure corresponding to branches 304, 306, 308. In the depicted branches 304, 306, 308, all unmodified nodes are marked with dotted frames; these nodes are not separately stored for the branch, but are read from the active version of the parent branch when needed, as explained in more detail below.

FIG. 4A shows the inactive context for the trunk (i.e., branch 304). Herein, the attributes of nodes 103 and 105 have been changed from “Process Step 1a” to “Process Step 1b” and from “Process Step 3a” to “Process Step 3b,” respectively. In addition, a new process node with ID 107 and attribute “Process 2” has been created. The modified nodes and the new node are stored locally in the inactive version. FIG. 4B shows branch B1 306. Herein, the attribute of node 103 has been changed from “Process Step 1a” (as reflected in the parent version) to “Process Step 1c.” Further, node 104 (“Process Step 2”) has been deleted, as indicated by the trash-bin symbol, and a new process-step node with ID 106 and attribute “Process Step 4” has been added. FIG. 4C shows branch B2 308. The only change made in this branch is the modification of node 103 from “Process Step 1a” to “Process Step 1d.”

The data associated with the above-described business-process structure in its four versions—active trunk 302, inactive trunk (i.e., branch 304), branch B1 306, and branch B2 308—may be stored in a single database; the table depicted in FIG. 5 illustrates an example database representation 500. To identify the different branch versions, the database has been extended (compared with a database storing only a single version) with two key fields. Thus, the database now has three key fields: an ID field 502 storing the unique node ID (e.g., node 101, 102, 103, etc.), a branch field 504 storing a unique key for the branch (e.g., R for the root, B1, and B2), and a version flag field 506 indicating whether the version is active (A) or inactive (I). In some embodiments, the version flag field 506 may also indicate that a version is a parent branch base version (B); usage of such base versions is explained further below. (In alternative embodiments in which inactive branches are treated as ordinary child branches (rather than a different context of a branch), two key fields may suffice, one for the unique node ID and one for the unique branch ID.) The database 500 may also contain one or more attribute/object fields 508. In addition, in the depicted example, the database 500 contains a “deleted” flag field 510 that is marked whenever a node has been deleted in a particular version. As can be seen from the table of FIG. 5, each node occurring in any of the branches has at least one entry (i.e., appears in at least one row), but nodes that differ between multiple versions have multiple entries, one for the root and one for each child branch in which it differs from the root. Note that, while only one table is shown in FIG. 5 for simplicity, process-structure data may in reality be stored in multiple database tables (e.g., different tables for structure data, attribute values, and language-dependent information).

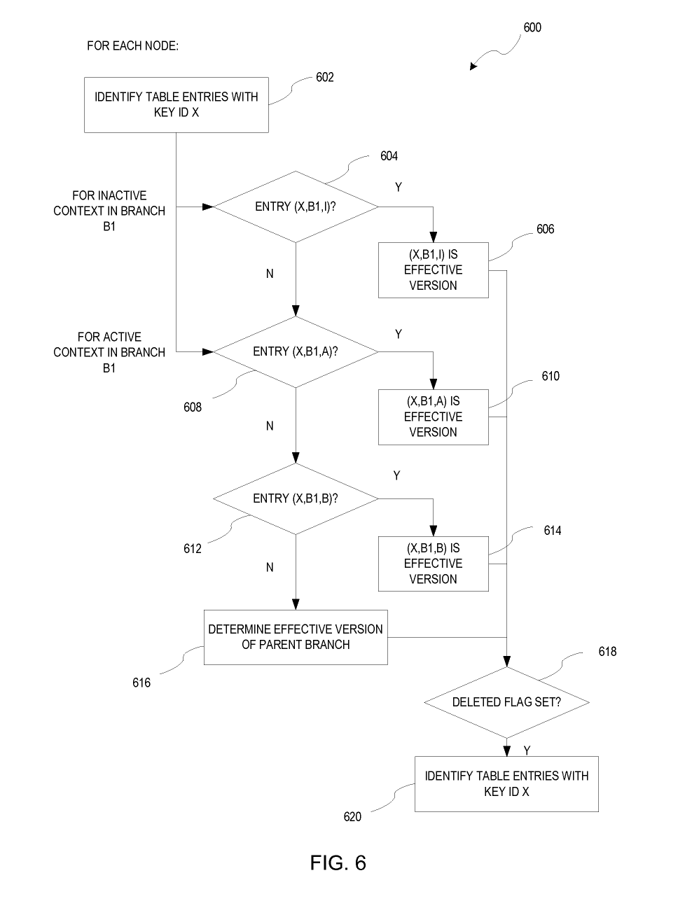

From a database such as, for instance, that depicted in FIG. 5, the process structure can be reconstructed for any specified branch context. This reconstruction generally involves determining, for each node of the structure, the effective version of that node; FIG. 6 illustrates a method 600 for doing so, with reference to the branch tree of FIG. 3. As depicted, for a node with node ID X, the method may begin with identifying all table entries with the key ID X (602). Then a decision tree may be traversed to select the effective entry from among the identified entries. In more detail, if the branch context is B1 (inactive), it is determined whether an entry with key (X, B1, I) exists (604). If such an entry exists, then this is the effective version (606). If not, it is next determined whether an entry with key (X, B1, A) exists (608); the same determination is done in the first place if the branch context is B1 (active). If the entry does exist, then this is the effective version (610). If not, it is next determined whether an entry with key (X, B1, B) exists (612). If it does, then this is the effective version (614). If not, the effective version is the effective version of the parent branch (616), which can be determined in an analogous manner by checking whether an entry exists for the inactive parent context I, active parent context A, or the parent's parent (i.e., grandparent's) base version B, and if none of these exists, the effective version of the parent branch is the effective version of the grandparent's branch. As will be appreciated, this procedure is recursive in nature; it converges (i.e., yields a result for each node) because the trunk contains a complete version of the process structure. In principle, the number of levels in the branch tree, and thus the number of recursions, is unlimited. In practice, however, the branch tree typically has only two levels, or in special use cases three. Thus, the recursive method tends to converge quickly and the use of delta information does not result in too much overhead. Returning to FIG. 6, finally, it is determined whether the “deleted” flag is set for the effective version (618); if it is, then the node with ID X does not exist in the specified context (620).

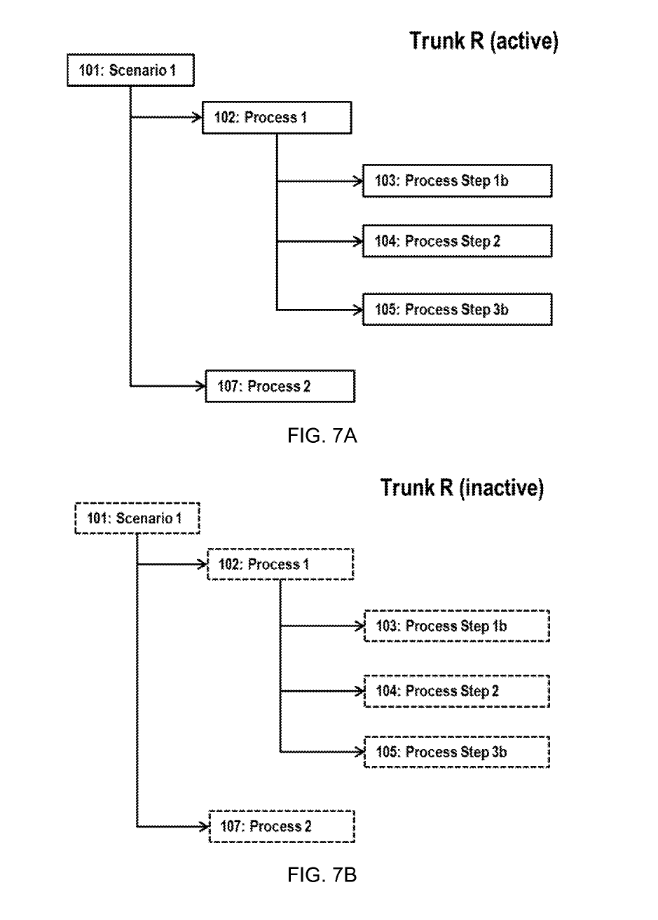

A modified version of a process structure may, at some point, be deployed, or “merged” into the active version. For example, the inactive context of a branch may serve as a working environment in which short-term corrections can be made initially without touching the productive version, i.e., the active context, but to implement the corrections in the real world, the changes made in the inactive context are eventually brought back to the active context—in other words, the inactive version is “activated.” Since the active context is frozen and no conflicts can arise, this can be accomplished simply by turning the previously inactive version into the active version; for the example inactive version shown in FIG. 4A, the resulting new active version is depicted in FIG. 7A. The new inactive version is empty, as shown in FIG. 7B.

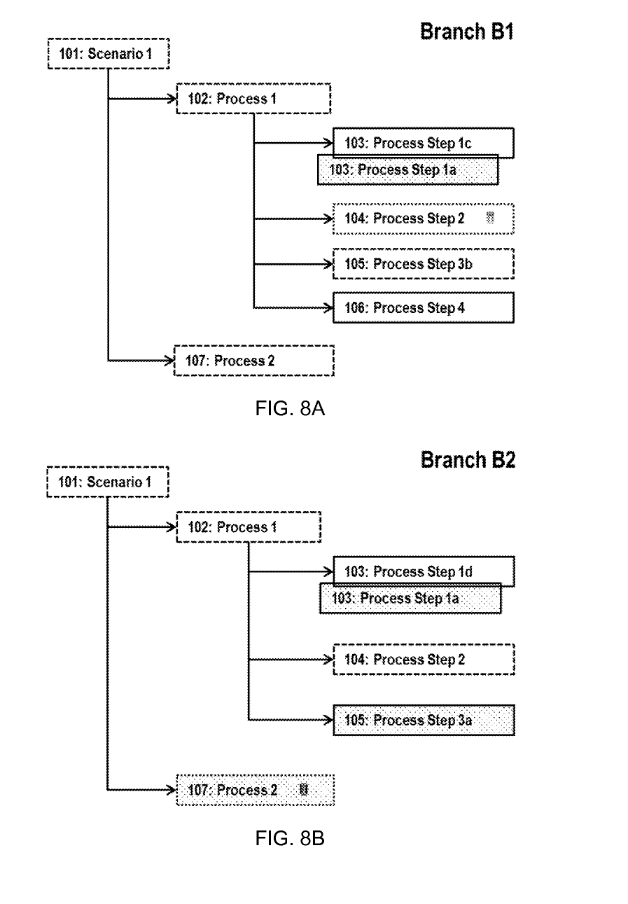

In situations where changes to a process structure are made in parallel in multiple branches (including inactive versions of a branch) that are, thereafter, deployed sequentially, such deployment is generally more complex, as changes made in a later-deployed branch may have been recorded relative to an outdated parent version, i.e., the parent version as it existed prior to activation of an earlier-deployed modified branch. To avoid inconsistencies between multiple modified versions at the time of deployment, changes made in the active parent branch context, e.g., by virtue of the activation of an inactive context, may be propagated to the child branches. The manner in which this propagation is effected depends generally on the isolation level of the child branch, and is illustrated in FIGS. 8A and 8B. For both isolation level 1 and isolation level 2, the original version of the parent branch (i.e., the version as it existed before the change was made to the parent) is stored in a “parent base” version of the child branch for all nodes in which a conflict arises because the node was changed both in the parent and the child branch.

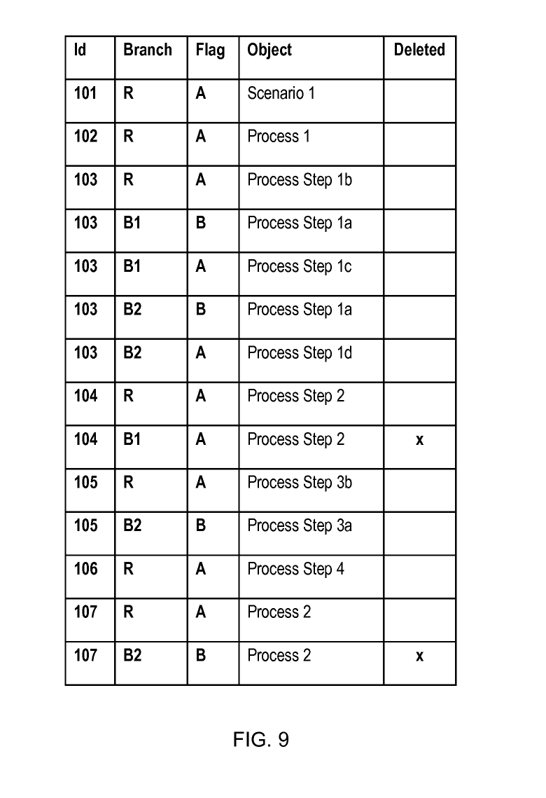

FIG. 8A shows how branch B1, as illustrated in FIG. 4B, is updated based on the activation of the previously inactive parent context depicted in FIG. 4A. A conflict arises for node 103, which was “Process Step 1a” in the original parent version, and was changed to “Process Step 1b” in the previously inactive, now activated parent context and to “Process Step 1c” in the child branch B1. To reflect the original parent version relative to which the change in B1 was made, this original version is stored in a parent branch base version B of branch B1. In the updated database for the process structure, shown in FIG. 9, the parent branch base version amounts to a separate entry with key (103,B1,B) and attribute “Process Step 1a.” Note that the attribute for node 103 in the active root branch, corresponding to key (103,R,A), has been changed relative to the database shown in FIG. 5 and is now “Process Step 1b,” and there is no longer any entry for node 103 in the inactive root branch (which is now empty). Since branch B1 is of isolation level 1, all non-conflicting changes made to the parent branch, i.e., modifications to nodes that were left untouched in branch B1 itself, are immediately visible in B1—they do not require any new or changed database entries for branch B1, but simply show up in the reconstructed process structure in the B1 context. Thus, node 105, which was modified to “Process Step 3b” in the parent branch, and node 107 (“Process 2”), which was newly added to the parent branch, are now shown in FIG. 8A for branch B1 in the form of dotted frames (as if they had always been there).

FIG. 8B shows how strictly isolated (i.e., isolation level 2) child branch B2, previously illustrated in FIG. 4C, is updated based on the activation of the previously inactive parent context depicted in FIG. 4A. In branch B2, parent—branch base versions are stored for all nodes that have been changed in the parent regardless of whether the changes are conflicting or non-conflicting; in this manner, the changes to the parent are “hidden” in branch B2 (rather than being immediately visible). Just as in branch B1, a conflict exists for node 103 between the change made in the parent (to “Process Step 1b”) and the change made in B2 (to “Process Step 1d”); this conflict is isolated by saving the parent's original version, “Process Step 1a,” in a parent branch base version in branch B2. In addition, parent branch base versions are added in branch B2 for nodes 105 and 107, which were changed in the parent, but left untouched in B2 itself. To signify that node 107 did not exist in the original parent version, the parent branch base version of B2 marks this node as “deleted.” In the database representation shown in FIG. 9, branch B2 is reflected in four entries: one entry storing the active B2 version of node 103, which differs from the parent, and three entries storing the parent branch base versions for nodes 103, 105, and 107.

The parent branch base versions that are stored in child branches at the time a change is made to the parent may be used to resolve all isolated conflicts when the child branch is eventually deployed, i.e., merged with the parent. In preparation for deployment of a child branch, all nodes with conflicting changes may be identified. The IDs of conflicting nodes may be determined simply by selecting all IDs for which a parent branch base version exists in the branch. Since this process does not involve any content comparisons, it may execute very fast. In the above-illustrated example of branch B1, the only conflicting node is the one with ID 103.

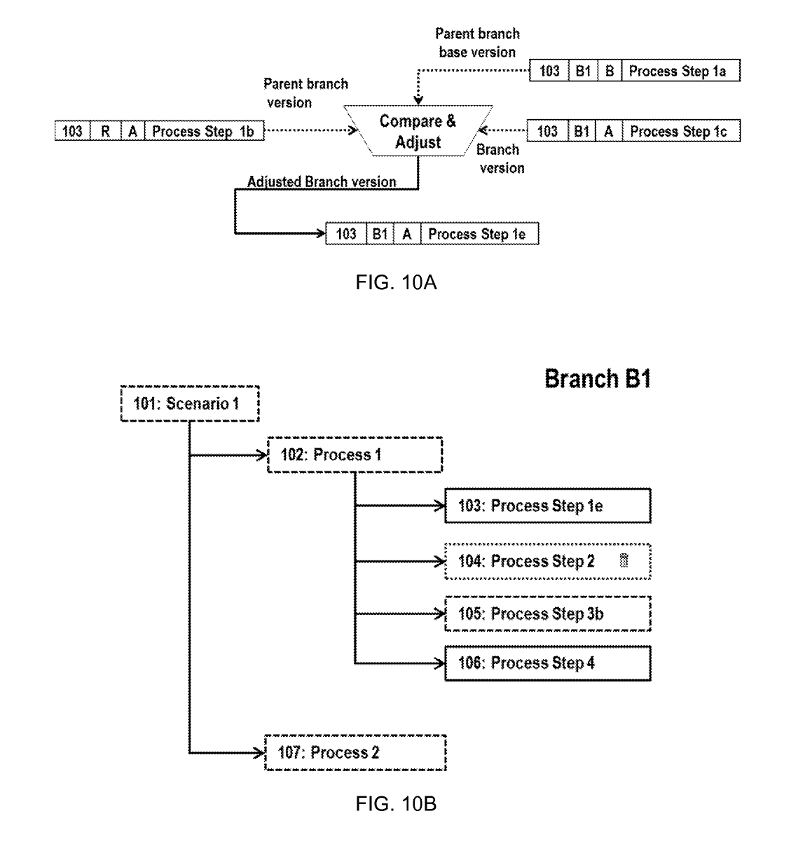

Once a conflicting node has been identified, the conflict may be resolved by a comparison between the different, conflicting versions for that node and the adjustment of the node based thereon. The conflicting versions may include the parent branch version (i.e., the effective version of the parent branch), the parent branch base version (i.e., the version stored in the child branch with key (node ID, branch ID, B)), and the effective branch version (i.e., the version stored in the child branch with key (node ID, branch ID, A or I). For example, as illustrated in FIG. 10A, the three versions of node 103 associated with branch B1 are “Process Step 1b” (the effective parent version), “Process Step 1a” (the parent branch base version), and “Process Step 1c” (the branch version). The user, recognizing that the change made in the child branch was based on a now-outdated parent version, may decide to implement the change made in the child branch (thereby rendering the change to the parent version moot), use the effective parent version instead (thereby discarding the change made in the child branch), or change the node altogether, i.e., create a completely new version different from all stored versions. In principle, the user may also choose to go back to the original parent version, thereby overwriting the change made in the parent and discarding the change made in the child branch; in practice, however, there will rarely be reason to do so. In the example shown in FIG. 10A, the compare-and-adjust process results in the creation of a new node version, “Process Step 1e.” The updated branch B1, resulting from the compare-and-adjust process, is shown in FIG. 10B.

In some embodiments, the compare-and-adjust process involves manual input, i.e., a human-made decision as to the preferable node version. In alternative embodiments, conflict resolution for nodes may be accomplished automatically, e.g., based on a set of rules implemented by a rules engine. For example, a selection may be made based on the date on which a change was made (e.g., such that a change made in a child branch trumps a change made in the parent if and only if the change in the child branch was made after the change in the parent took effect, i.e., after the parent branch base version was stored in the child branch), the privilege level of the user who made the change, the priority level of a project associated with the branch, other criteria, and/or combinations thereof.

As explained previously, in strictly isolated branches (e.g., branch B2), all changes made to the parent (not only the conflicting ones) are “hidden,” i.e., stored as parent branch base versions in the child branch. The deployment of a strictly isolated branch may, therefore, involve a compare-and-adjust process for all of the nodes for which parent branch base versions exist. Conflicts may be resolved by a three-way compare-and-adjust process as described above with respect to FIG. 10A. For non-conflicting changes, the user may have the option to use a two-way compare-and-adjust process to compare the parent branch base version with the newer effective parent branch version and make a selection therebetween.

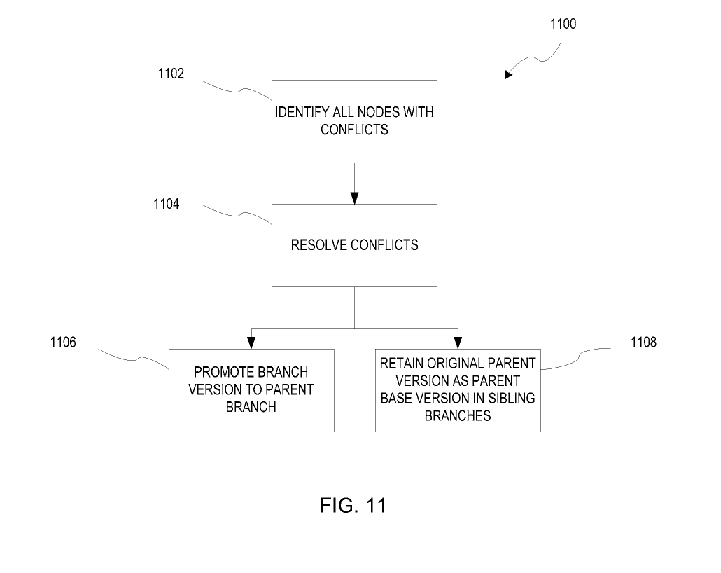

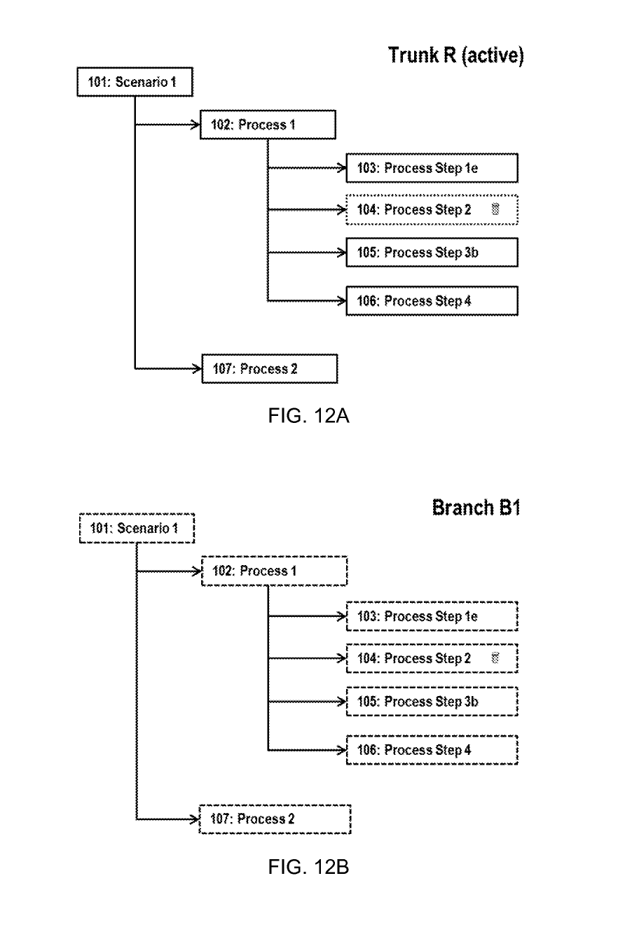

FIG. 11 illustrates a method 1100 for deploying a branch version of a process structure, in accordance with an embodiment. The method 1100 involves identifying all nodes for which a conflict exists between the branch version and the parent version (1102), and adjusting the attributes for the identified nodes to resolve the conflicts (1104), e.g., in the manner described with respect to FIG. 10A. Once all conflicts have been resolved, the branch version is promoted to its parent branch (1106), i.e., the node attributes of the branch version are stored into the parent branch and removed from local branch storage. The previous attributes of all modified nodes are retained as parent branch base version in any still-existing child branches of the parent (i.e., any sibling branches of the branch version currently deployed) (1108). The promotion of branch B1 into the trunk R, and the resulting empty branch B1, are illustrated in FIGS. 12A and 12B.

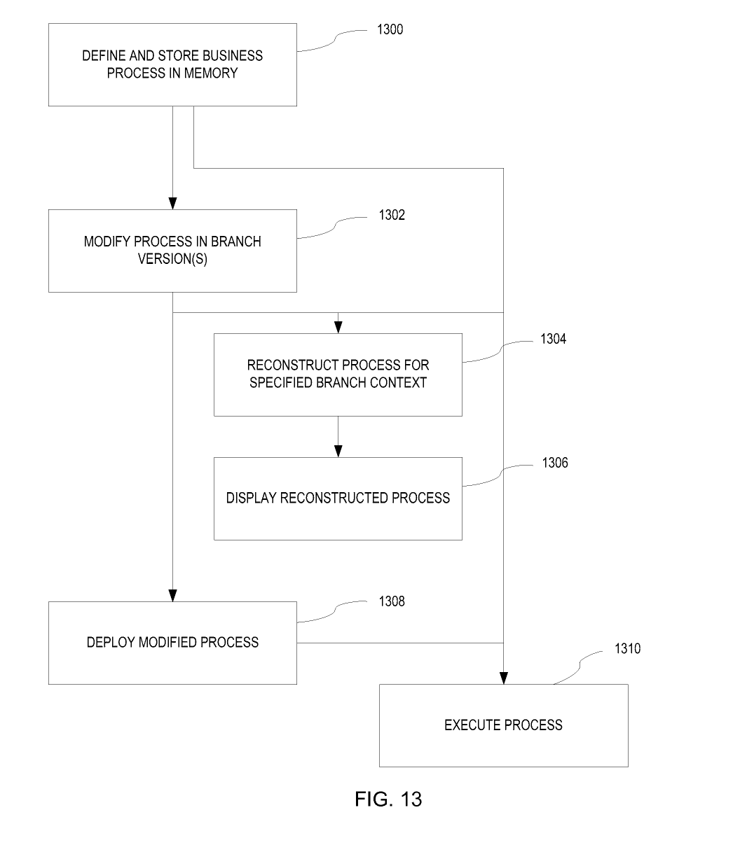

FIG. 13 summarizes methods for creating, modifying, deploying, and executing business process structures in accordance herewith. A business process structure may be defined and stored in memory (1300), e.g., in the form of a database and/or other data structure 210. In some embodiments, the definition of the tree structure of the business process is accomplished through user input provided, e.g., using a process editor 222. Once the nodes and relations therebetween are specified, attributes may be associated with the nodes. The business process structure may be modified in one or more branch versions (1302), e.g., again based on user input provided via the process editor 222, and reflected in corresponding updates to the data structure 210. Modifications may include additions or deletions of nodes, as well as changes to node attributes. For any specified branch context, the business process structure may be reconstructed from the stored data (1304), e.g., using the version manager 220. The reconstructed modified version (and/or the original version) may be displayed (1306), e.g., using the process editor 222, to provide an overview of the modifications to the user. At some point, one of the branch versions may be deployed (1308), e.g., propagated to its parent branch (which, in a two-level hierarchy, is the trunk). Other branch versions may be created and/or deployed thereafter. At any point, a selected version of the business process, e.g., the original version or one of the modified branch versions, may be executed (1310), e.g., resources associated with the business process version may be accessed (e.g., software applications may be executed, documents may be modified, data retrieved or created, etc.) in the order specified by the process structure.

### Modules, Components, and Logic

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Software Architecture

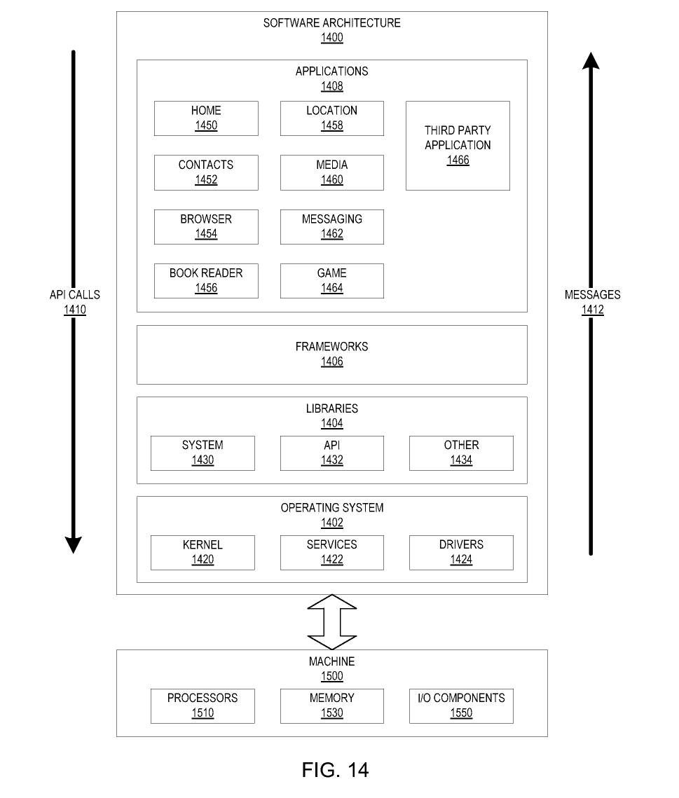

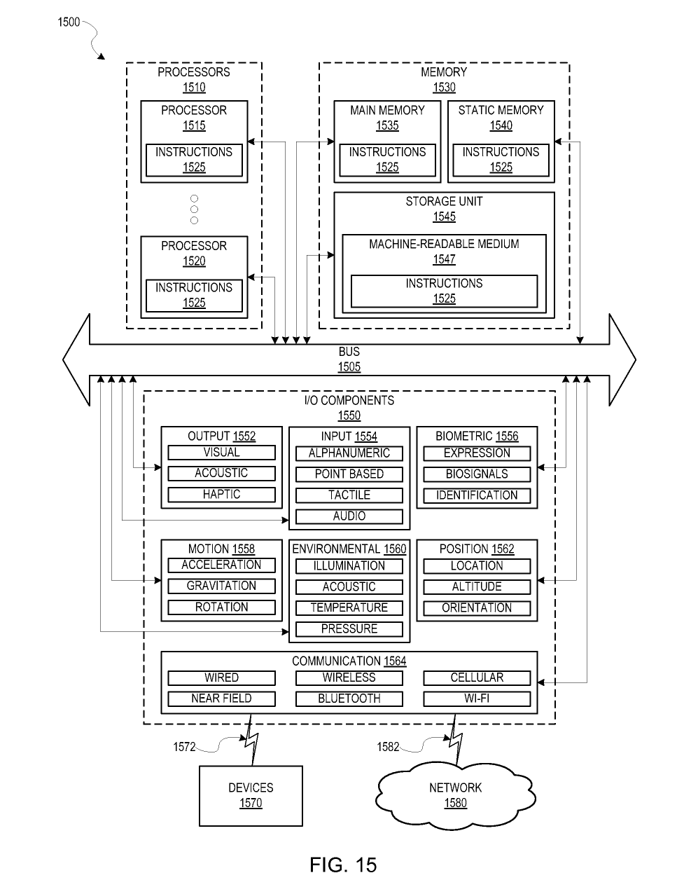

FIG. 14 is a block diagram illustrating an architecture of software 1400 implementing the methods described herein. FIG. 14 is merely a non-limiting example of a software architecture and it will be appreciated that many other architectures may be implemented to facilitate the functionality described herein. The software 1400 may be executing on hardware such as a machine 1500 of FIG. 15 that includes processors 1510, memory 1530, and I/O components 1550. In the example architecture of FIG. 14, the software 1400 may be conceptualized as a stack of layers where each layer may provide particular functionality. For example, the software 1400 may include layers such as an operating system 1402, libraries 1404, frameworks 1406, and applications 1408. Operationally, the applications 1408 may invoke application programming interface (API) calls 1410 through the software stack and receive messages 1412 in response to the API calls 1410.

The operating system 1402 may manage hardware resources and provide common services. The operating system 1402 may include, for example, a kernel 1420, services 1422, and drivers 1424. The kernel 1420 may act as an abstraction layer between the hardware and the other software layers. For example, the kernel 1420 may be responsible for memory management, processor management (e.g., scheduling), component management, networking, security settings, and so on. The services 1422 may provide other common services for the other software layers. The drivers 1424 may be responsible for controlling and/or interfacing with the underlying hardware. For instance, the drivers 1424 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 1404 may provide a low-level common infrastructure that may be utilized by the applications 1408. The libraries 1404 may include system libraries 1430 (e.g., C standard library) that may provide functions such as memory allocation functions, string manipulation functions, mathematic functions, and the like. In addition, the libraries 1404 may include API libraries 1432 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1404 may also include a wide variety of other libraries 1434 to provide many other APIs to the applications 1408.

The frameworks 1406 may provide a high-level common infrastructure that may be utilized by the applications 1408. For example, the frameworks 1406 may provide various graphic user interface (GUI) functions, high-level resource management, high-level location services, and so forth. The frameworks 1406 may provide a broad spectrum of other APIs that may be utilized by the applications 1408, some of which may be specific to a particular operating system or platform.

The applications 1408 may include a home application 1450, a contacts application 1452, a browser application 1454, a book reader application 1456, a location application 1458, a media application 1460, a messaging application 1462, a game application 1464, and a broad assortment of other applications such as a third-party application 1466. In a specific example, the third-party application 1466 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1466 may invoke the API calls 1410 provided by the operating system to facilitate functionality described herein.

### Example Machine Architecture and Machine-Readable Medium

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1525 (e.g., software, a program, an application, an applet, an app, or other executable code) for causing the machine 1500 to perform any one or more of the methodologies discussed herein may be executed. In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1525, sequentially or otherwise, that specify actions to be taken by the machine 1500. Further, while only a single machine 1500 is illustrated, the term “machine” shall also be taken to include a collection of machines 1500 that individually or jointly execute the instructions 1525 to perform any one or more of the methodologies discussed herein.

The machine 1500 may include processors 1510, memory 1530, and I/O components 1550, which may be configured to communicate with each other via a bus 1505. In an example embodiment, the processors 1510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1515 and a processor 1520 that may execute the instructions 1525. The term “processor” is intended to include multi-core processor that may comprise two or more independent processors (also referred to as “cores”) that may execute instructions contemporaneously. Although FIG. 15 shows multiple processors 1510, the machine 1500 may include a single processor with a single core, a single processor with multiple cores (e.g., a multi-core processor), multiple processors with a single core, multiple processors with multiples cores, or any combination thereof.

The memory 1530 may include a main memory 1535, a static memory 1540, and a storage unit 1545 accessible to the processors 1510 via the bus 1505. The storage unit 1545 may include a machine-readable medium 1547 on which are stored the instructions 1525 embodying any one or more of the methodologies or functions described herein. The instructions 1525 may also reside, completely or at least partially, within the main memory 1535, within the static memory 1540, within at least one of the processors 1510 (e.g., within a processor's cache memory), or any suitable combination thereof, during execution thereof by the machine 1500. Accordingly, the main memory 1535, the static memory 1540, and the processors 1510 may be considered machine-readable media 1547.

As used herein, the term “memory” refers to a machine-readable medium 1547 able to store data temporarily or permanently, and may be taken to include, but not be limited to, random-access memory (RAM), read-only memory (ROM), buffer memory, flash memory, and cache memory. While the machine-readable medium 1547 is shown in an example embodiment to be a single medium, the term “machine-readable medium” should be taken to include a single medium or multiple media (e.g., a centralized or distributed database, or associated caches and servers) able to store the instructions 1525. The term “machine-readable medium” shall also be taken to include any medium, or combination of multiple media, that is capable of storing instructions (e.g., instructions 1525) for execution by a machine (e.g., machine 1500), such that the instructions, when executed by one or more processors of the machine 1500 (e.g., processors 1510), cause the machine 1500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 1550 may include a wide variety of components to receive input, provide and/or produce output, transmit information, exchange information, capture measurements, and so on. It will be appreciated that the I/O components 1550 may include many other components that are not shown in FIG. 15. In various example embodiments, the I/O components 1550 may include output components 1552 and/or input components 1554. The output components 1552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 1550 may include biometric components 1556, motion components 1558, environmental components 1560, and/or position components 1562 among a wide array of other components. For example, the biometric components 1556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1558 may include acceleration sensor components (e.g., accelerometer), gravitation sensor components, rotation sensor components (e.g., gyroscope), and so forth. The environmental components 1560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 1562 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 1550 may include communication components 1564 operable to couple the machine 1500 to a network 1580 and/or devices 1570 via coupling 1582 and coupling 1572 respectively. For example, the communication components 1564 may include a network interface component or other suitable device to interface with the network 1580. In further examples, communication components 1564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1570 may be another machine and/or any of a wide variety of peripheral devices (e.g., a peripheral device coupled via a Universal Serial Bus (USB)).

Moreover, the communication components 1564 may detect identifiers and/or include components operable to detect identifiers. For example, the communication components 1564 may include Radio Frequency Identification (RFID) tag reader components, NFC smart tag detection components, optical reader components (e.g., an optical sensor to detect one-dimensional bar codes such as Universal Product Code (UPC) bar codes, multi-dimensional bar codes such as Quick Response (QR) codes, Aztec codes, Data Matrix, Dataglyph, MaxiCode, PDF417, Ultra Code, UCC RSS-2D bar codes, and other optical codes), acoustic detection components (e.g., microphones to identify tagged audio signals), and so on. In additional, a variety of information may be derived via the communication components 1564, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 1580 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1580 or a portion of the network 1580 may include a wireless or cellular network and the coupling 1582 may be a Code Division Multiple Access (CDMA) connection, a Global System for Mobile communications (GSM) connection, or another type of cellular or wireless coupling. In this example, the coupling 1582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1525 may be transmitted and/or received over the network 1580 using a transmission medium via a network interface device (e.g., a network interface component included in the communication components 1564) and utilizing any one of a number of well-known transfer protocols (e.g., hypertext transfer protocol (HTTP)). Similarly, the instructions 1525 may be transmitted and/or received using a transmission medium via the coupling 1572 (e.g., a peer-to-peer coupling) to the devices 1570. The term “transmission medium” shall be taken to include any intangible medium that is capable of storing, encoding, or carrying instructions 1525 for execution by the machine 1500, and includes digital or analog communications signals or other intangible media to facilitate communication of such software.

Furthermore, the machine-readable medium 1547 is non-transitory (in other words, not having any transitory signals) in that it does not embody a propagating signal. However, labeling the machine-readable medium 1547 “non-transitory” should not be construed to mean that the medium is incapable of movement; the medium should be considered as being transportable from one physical location to another. Additionally, since the machine-readable medium 1547 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

What is claimed is:

1. A system comprising:
a memory storing a database including one or more entries for each node of a business process structure, the one or more entries for each node comprising a trunk entry and, for each branch version in which the node is modified, a branch entry, each trunk entry and each branch entry comprising a key and at least one attribute, the key comprising at least a node identifier and a branch identifier; and
one or more modules, forming part of one or more hardware processor arrangements, configured to update the database:
to reflect modifications to nodes made in one or more branch versions,
to resolve conflicts between a branch version and a parent branch version thereof, and
to reflect merging of the branch version into its parent branch version.

2. The system of claim 1, wherein the one or more modules are further configured to provide a user interface for receiving user input about relationships between the nodes of the business process structure and the attributes associated therewith.

3. The system of claim 1, wherein the one or more modules are further configured to reconstruct the business process structure for a given branch context based on the database.

4. The system of claim 1, wherein the one or more modules are further configured to execute the business process structure by sequentially accessing resources associated with the nodes in accordance with the business process structure.

5. The system of claim 4, wherein the resources comprise at least one of application programs or data identified in the attributes of the nodes.

6. The system of claim 1, wherein the key for each entry further comprises an indicator of a branch type, the branch type being one of an active, inactive, or parent base type.

7. The system of claim 1, wherein the database comprises, within each branch version, one or more entries only for those nodes that are modified in the branch version relative to the parent branch version thereof.

8. A method comprising:
defining, in a computer memory, a business process structure comprising a plurality of nodes and hierarchical relations between the nodes;
storing in the computer memory, for each node of the business process structure, a trunk entry comprising a key and at least one attribute associated with the node, the key comprising a node identifier;
modifying the business process structure in one or more branch versions by storing in the computer memory, for each of the one or more branch versions, a branch entry for each node modified within the branch version, the branch entry comprising a key and at least one modified attribute associated with the node, the key comprising the node identifier for the modified node and a branch identifier associated with the branch version; and
using a processor in communication with the computer memory, reconstructing a selected branch version of the business process structure based on the trunk entries and the branch entries for the selected branch version.

9. The method of claim 8, wherein reconstructing the selected branch version of the business process structure comprises identifying, for the selected branch version, an effective version of each node based on the keys of the trunk entries and the branch entries.

10. The method of claim 8, wherein reconstructing the selected branch version of the business process structure comprises executing the selected branch version.

11. The method of claim 8, wherein reconstructing the selected branch version of the business process structure comprises displaying the selected branch version of the business process structure.

12. The method of claim 8, further comprising merging a branch version of the business process structure into a parent version thereof.

13. The method of claim 8, wherein the one or more branch versions comprise first and second child branch versions derived from a parent branch version thereof, the method further comprising merging the first child branch version into the parent branch version, and propagating modifications of the parent branch version resulting from the merging to the second child branch version.

14. The method of claim 13, wherein the parent branch version is a trunk version defined by the trunk entries.

15. The method of claim 13, wherein propagating the modifications comprises storing in the second child branch version, for at least each node modified in both the parent branch version and the second child branch version, a parent base entry reflecting the at least one attribute of the node in the parent branch version prior to the merging.

16. The method of claim 15, wherein propagating the modifications comprises storing in the second child branch version, for each node modified in the parent branch version, a parent base entry reflecting the at least one attribute of the node in the parent branch version prior to the merging.

17. The method of claim 15, further comprising, following merging of the first child branch version into the parent branch version, merging the second child branch version into the parent branch version.

18. The method of claim 17, wherein merging the second child branch version into the parent branch version comprises comparing, for each node modified in both the parent branch version and the second child branch version, an entry in the parent branch version, the branch entry in the second child branch version, and the parent base entry stored in the second child branch version, and adjusting a node attribute based on the comparison.

19. The method of claim 8, wherein modifying the business process structure comprises at least one of adding a node, deleting a node, or modifying an attribute of a node.

20. A non-transitory machine-readable medium storing processor-executable instructions which, when executed by a processor, cause the processor to:
store, in a memory, one or more entries for each node of a business process structure, the one or more entries for each node comprising a trunk entry and, for each branch version in which the node is modified, a branch entry, each trunk entry and each branch entry comprising a key and at least one attribute, the key comprising at least a node identifier and a branch identifier;
update the stored entries to reflect modifications to nodes made in one or more branch versions; and
update the stored entries to reflect merging of a selected branch version into its parent branch version.
